(19) United States
(12) Patent Application Publication
(10) Pub. No.: US 2004/0164816 A1
(43) Pub. Date: Aug. 26, 2004

(54) Nonreciprocal circuit element with reduced insertion loss and excellent manufacturability

(75) Inventors: Isao Ishigaki, Fukushima-ken (JP); Chiaki Aikawa, Miyagi-ken (JP); Akira Sakai, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/781,423

(22) Filed: Feb. 18, 2004

(30) Foreign Application Priority Data
Feb. 24, 2003 (JP) 2003-046464

(51) Int. Cl. H01P 1/32

(52) U.S. Cl. 333/1.1; 333/24.2

(57) ABSTRACT

A nonreciprocal circuit element with reduced insertion loss and excellent manufacturability is provided. The nonreciprocal circuit element includes first, second, and third central conductors 5, 6, and 7 located on a ferrite member 4 on different planes in a vertical direction with dielectric bodies sandwiched therebetween so that parts thereof cross each other in the vertical direction, a first yoke 1 arranged so as to cover a magnet 2, a second yoke 3 that constitutes a magnetic closed circuit together with the first yoke 1, and an insulating base 8 made of a molded synthetic resin for positioning the ferrite member 4. A plurality of input and output terminals 9 and 10 made of a material having a smaller electric resistance than that of the second yoke 3 is mounted in the insulating base 8. As a result, it is possible to obtain a nonreciprocal circuit element with reduced insertion loss compared to the conventional nonreciprocal circuit design.

### BACKGROUND OF THE INVENTION

1. Field of the Invention

The present invention relates to a nonreciprocal circuit element such as an isolator and a circulator, which is applied to an antenna combiner.

2. Description of the Related Art

The structure of a conventional nonreciprocal circuit element will now be described with reference to FIG. 7. The conventional nonreciprocal circuit element includes a boxlike first yoke 51 made of an iron plate, a plate-shaped magnet 52 arranged in the first yoke 51, a ferrite member 53 arranged under the magnet 52, first, second, and third central conductors 54, 55, and 56 made of a metal plate, which are mounted to the ferrite member 53 at intervals of 120° and parts of which cross each other, a boxlike resin case 57, and a U-shaped second yoke 58 made of an iron plate, which is buried under the resin case 57.

The resin case 57 is provided with input and output terminals 59 and 60 made of an iron plate, which are buried in the resin case 57 in a state of being disconnected from the second yoke 58 and a terminal 61 integrally formed with the second yoke 58.

The ferrite member 53 to which the first, second, and third central conductors 54, 55, and 56 are attached is arranged in the resin case 57 so that earths 54a, 55a, and 56a at one end of each of the first, second, and third central conductors 54, 55, and 56 are connected to the second yoke 58.

Chip-type capacitors 62, 63, and 64 and a chip-type resistor 65 are arranged in the resin case 57 so that electrodes on the bottom faces of the capacitors 62, 63, and 64 and an electrode 65a at one end of the resistor 65 are connected to the second yoke 58.

Ports 54b and 55b at the other ends of the first and second central conductors 54 and 55 are soldered to electrodes on the top faces of the capacitors 62 and 63 and are led from the input and output terminals 59 and 60. Further, a port 56b at the other end of the third central conductor 56 is soldered to the top electrode of the capacitor 64 and the top face of an electrode 65b at the other end of the resistor 65.

The first and second yokes 51 and 58 are combined with each other with the magnet 52 and the ferrite member 53 being sandwiched therebetween so that a magnetic closed circuit is formed by the first and second yokes 51 and 58. As a result, an isolator that is a nonreciprocal circuit element is formed (For example, refer to Patent Document 1).

[Patent Document 1]

Japanese Unexamined Patent Application Publication No. 2001-24406

Such a conventional nonreciprocal circuit element has a problem in that a large amount of insertion loss occurs because the input and output terminals 59 and 60 are made of iron.

### SUMMARY OF THE INVENTION

An object of the present invention is to provide a nonreciprocal circuit element with reduced insertion loss and excellent manufacturability.

As first means for achieving the object, there is provided a nonreciprocal circuit element, comprising a flat plate-shaped ferrite member, first, second, and third central conductors located on the ferrite member on different planes in a vertical direction with dielectric bodies sandwiched therebetween so that parts thereof cross each other in the vertical direction, a magnet arranged on the central conductors, a first yoke arranged so as to cover the magnet, a second yoke arranged on the bottom face of the ferrite member to constitute a magnetic closed circuit together with the first yoke, and an insulating base made of a molded synthetic resin for positioning the ferrite member. A plurality of input and output terminals made of a material having a smaller electric resistance than that of the second yoke is mounted on the insulating base.

Further, as second means' for achieving the object, the input and output terminals are made of copper or a copper alloy.

Further, as third means for achieving the object, the input and output terminals are buried in the insulating base.

Further, as fourth means for achieving the object, the second yoke is buried in the insulating base and is integrated with the insulating base.

Further, as fifth means for achieving the object, the bottom wall of the insulating base is provided with first and second recesses for exposing the second yoke. The ferrite member is arranged and positioned in the first recess. Further, earths of the central conductors located on the bottom face of the ferrite member are connected to the second yoke. A capacitor is arranged and positioned in the second recess. Further, a bottom electrode of the capacitor is connected to the second yoke.

Further, as sixth means for achieving the object, the ports are soldered to the top electrode of the capacitor and the input and output terminals.

Further, as seventh means for achieving the object, the top electrode of the capacitor and the top faces of the input and output terminals are arranged so that they are flush with each other.

Further, as eighth means for achieving the object, the input and output terminals and the second yoke are formed by punching and bending coil stocks and are integrated with the insulating base formed by molding.

### BRIEF DESCRIPTION OF THE DRAWINGS

FIG. 1 is an exploded perspective view of a nonreciprocal circuit element according to the present invention;

FIG. 2 is a plan view of a state in which a first yoke and a magnet are removed from the nonreciprocal circuit element according to the present invention;

FIG. 3 is a sectional view taken along the line 3-3 of FIG. 2;

FIG. 4 is a sectional view taken along the line 4-4 of FIG. 2;

FIG. 5 is an equivalent circuit diagram when the nonreciprocal circuit element according to the present invention is applied to an isolator;

FIG. 6 is an equivalent circuit diagram when the nonreciprocal circuit element according to the present invention is applied to a circulator; and

FIG. 7 is an exploded perspective view of a conventional nonreciprocal circuit element.

### DESCRIPTION OF THE PREFERRED EMBODIMENT

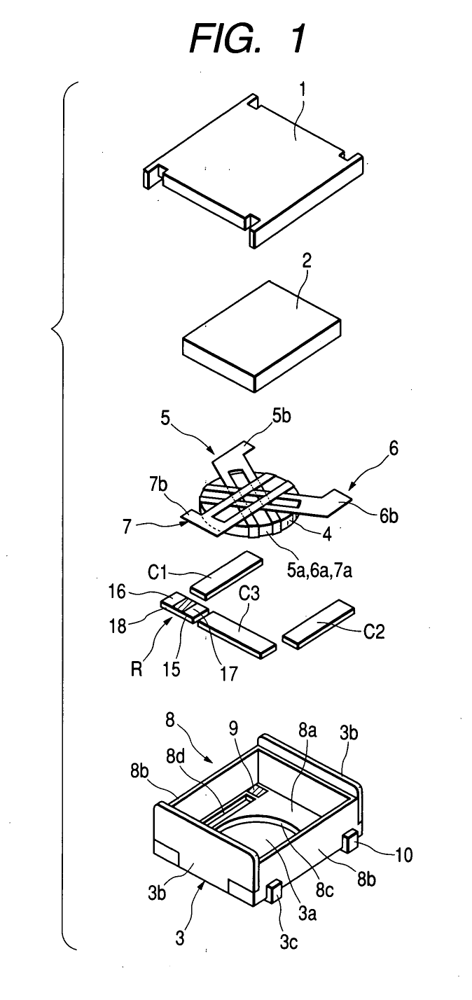

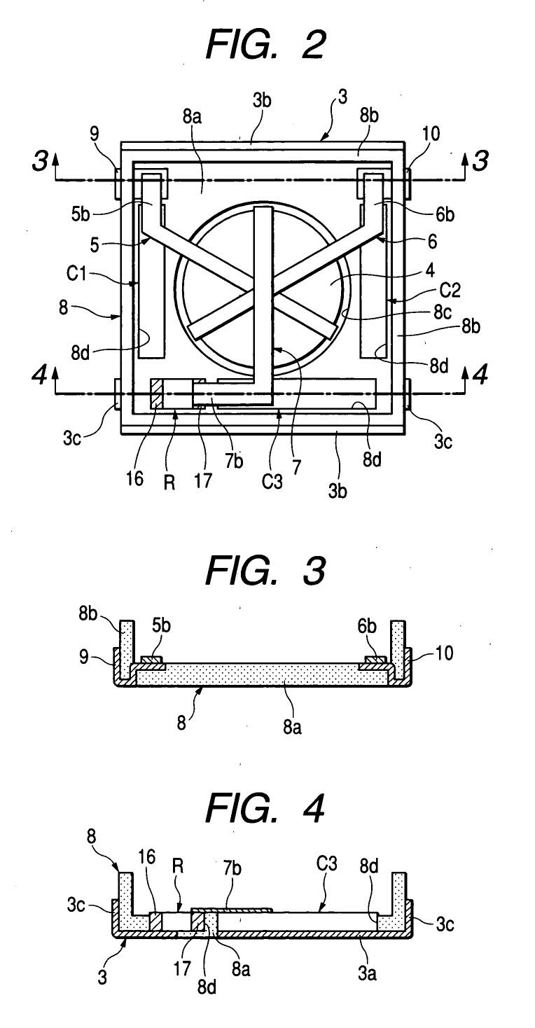

A nonreciprocal circuit element according to the present invention will now be described with reference to the accompanying drawings. FIG. 1 is an exploded perspective view of a nonreciprocal circuit element according to the present invention. FIG. 2 is a plan view of a state in which a first yoke and a magnet are removed from the nonreciprocal circuit element according to the present invention. FIG. 3 is a sectional view taken along the line 3-3 of FIG. 2. FIG. 4 is a sectional view taken along the line 4-4 of FIG. 2.

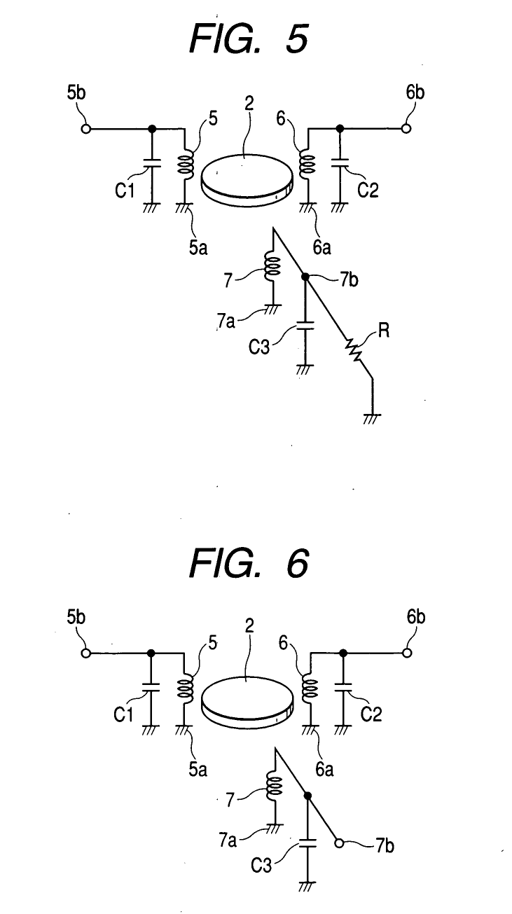

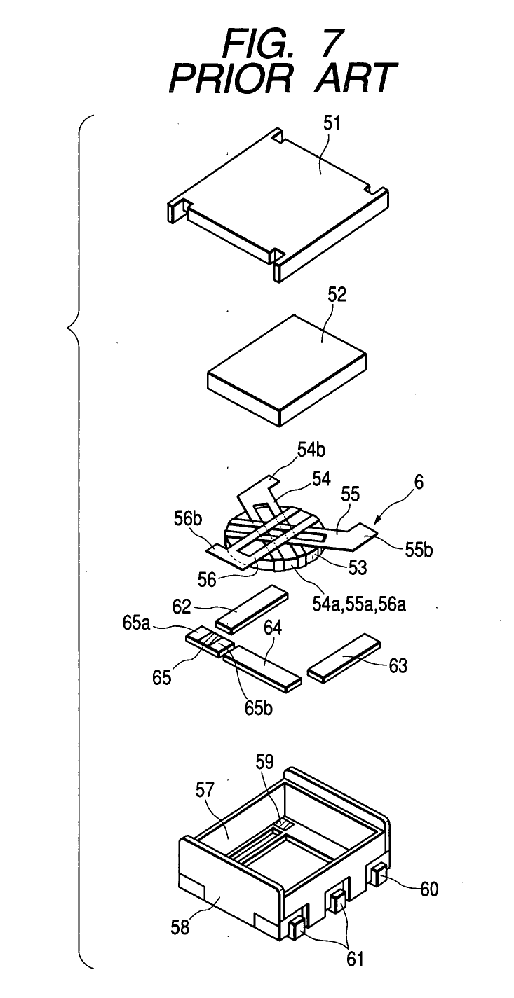

FIG. 5 is an equivalent circuit diagram when the nonreciprocal circuit element according to the present invention is applied to an isolator. FIG. 6 is an equivalent circuit diagram when the nonreciprocal circuit element according to the present invention is applied to a circulator.

The structure of the nonreciprocal circuit element according to the present invention will now be described with reference to FIGS. 1 to 4. A plate-shaped magnet 2 is mounted to a boxlike first yoke 1 made of a magnetic plate (an iron plate) by appropriate means in a state of being connected to the inside of the top plate of the first yoke 1.

A second yoke 3 made of a U-shaped magnetic plate (iron plate) includes a rectangular bottom plate 3a, a pair of opposite side plates 3b, which are bent upward from the opposite sides of the bottom plate 3a, and a terminal 3c bent from the bottom plate 3a.

The pair of side plates 3b of the second yoke 3 are combined with the first yoke 1 in a state where the second yoke 3 is arranged to face the first yoke 1, thereby forming a magnetic closed circuit.

A boxlike insulating base 8 made of a molded synthetic resin includes a rectangular bottom wall 8a, four side walls 8b extending upward from the four directions of the bottom wall 8a, a first circular recess 8c provided at the center of the bottom wall 8a, and a plurality of second rectangular recesses 8d provided in the bottom wall 8a so as to surround the first recess 8c.

The insulating base 8 is integrated with the second yoke 3 by molding so that the bottom plate 3a of the second yoke 3 is exposed through the first and second recesses 8c and 8d and, as illustrated in FIG. 4, the terminal 3c is exposed through the bottom face of the bottom wall 8a, and the external surfaces of the side walls 8b.

Plate-shaped input and output terminals 9 and 10 made of copper or a copper alloy having a smaller electric resistance than that of the second yoke (an iron plate) 3 are buried in the insulating base 8 so that, as illustrated in FIG. 3, one end of each of the input and output terminals 9 and 10 is exposed through the top face of the bottom wall 8a of the insulating base 8 and the other end of each of the input and output terminals 9 and 10 is exposed through the bottom face of the bottom wall 8a and the external surfaces of the side walls 8b.

That is, the second yoke 3 and the input and output terminals 9 and 10 are buried in the insulating base 8 so that the second yoke 3 and the input and output terminals 9 and 10 are integrated with the insulating base 8.

According to the manufacturing method, although not illustrated, a first coil stock made of copper or a copper alloy that forms the input and output terminals 9 and 10 is punched and bent by dies. A second coil stock made of iron that forms the second yoke 3 is punched and bent by dies. The first and second coil stocks are sequentially fed to a metal mold so as to form the insulating base 8 by molding. As a result, the second yoke 3 and the input and output terminals 9 and 10 are integrated with each other.

In this embodiment, the second yoke 3 and the input and output terminals 9 and 10 are buried in the insulating base 8 so that the second yoke 3 and the input and output terminals 9 and 10 are integrated with the insulating base 8. However, the input and output terminals 9 and 10 may be integrated with the insulating base 8 and the second yoke 3 formed by separate parts may be combined with the integrated parts.

In each of the chip-type first, second, and third capacitors C1, C2, and C3, although not illustrated herein, a top electrode made of silver is provided on the top face of an insulating plate made of ceramic, and a bottom electrode made of silver is provided on the bottom face of the insulating plate. As a result, a capacitor is formed between the top electrode and the bottom electrode that face each other.

The first, second, and third capacitors C1, C2, and C3 each having the above structure are arranged and positioned in the second recess 8d. Each of the bottom electrodes of the first, second, and third capacitors C1, C2, and C3 is connected (soldered) to the bottom plate 3a of the second yoke 3 exposed to the second recess 8d.

When the first, second, and third capacitors C1, C2, and C3 are arranged in the second recess 8d, the top electrodes of the first, second, and third capacitors C1, C2, and C3 are flush with the first and second input and output terminals 9 and 10 on the bottom wall 8a.

The chip-type resistor R comprises an insulating plate 15, a first electrode 16 made of silver, which is formed on the top face and the side faces of the insulating plate 15 at one end of the insulating plate 15, a second electrode 17 made of silver, which is formed on the top face, the side faces, and the bottom face of the insulating plate 15 at the other end of the insulating plate 15, and a resistive body 18 provided on the top face of the insulating plate 15 in a state of being electrically connected to the first and second electrodes 16 and 17.

As illustrated in FIG. 4, the resistor R is arranged in another second recess 8d adjacent to the second recess 8d in which the third capacitor C3 is arranged in a state of being juxtaposed to the third capacitor C3. Therefore, the first electrode 16 is secured and grounded to the bottom plate 3a of the second yoke 3 by soldering.

A flat plate-shaped ferrite member 4 made of yttrium iron garnet (YIG) is mounted on the bottom plate 3a of the second yoke 3.

First, second, and third central conductors 5, 6, and 7 made of thin conductive plates such as copper include earths 5a, 6a, and 7a to which one end of each of the first, second, and third central conductors 5, 6, and 7 is connected, and ports 5b, 6b, and 7b provided at the other ends thereof.

The first, second, and third central conductors 5, 6, and 7 are bent along the side faces and the top face of the ferrite member 4 and are provided on the top face of the ferrite member 4 at intervals of 120° in a state where the earths 5a, 6a, and 7a are arranged on the bottom face of the ferrite member 4.

Dielectric bodies (not illustrated) made of an insulating material are arranged among the first, second, and third central conductors 5, 6, and 7 so that the first, second, and third central conductors 5, 6, and 7 cross each other in a vertical direction in a state of being insulated from each other.

As mentioned above, the ferrite member 4 to which the first, second, and third central conductors 5, 6, and 7 are attached is arranged and positioned in the first recess 8c. Further, the earths 5a, 6a, and 7a are soldered to the bottom plate 3a of the second yoke 3 exposed to the first recess 8c thereby being electrically connected to the bottom plate 3a of the second yoke 3 in a state of being grounded.

In the first, second, and third central conductors 5, 6, and 7 arranged in the insulating base 8, the port 5b is soldered to the top electrode of the first capacitor C1 and the input and output terminal 9. Further, the port 6b is soldered to the top electrode of the first capacitor C2 and the input and output terminal 10. Moreover, the port 7b is soldered to the top electrode of the first capacitor C3 and the second electrode 17 of the resistor R.

The magnet 2 positioned in the first yoke 1 is arranged on the first, second, and third central conductors 5, 6, and 7. In this state, when the first yoke 1 is combined with the second yoke 3, the magnet 2 and the ferrite member 4 are sandwiched between the first yoke 1 and the second yoke 3. As a result, a nonreciprocal circuit element comprising an isolator is formed.

Although not illustrated, the nonreciprocal circuit element having such a structure is mounted on a circuit substrate having a conductive pattern so that the terminal 3c and the input and output terminals 9 and 10 are soldered to a desired conductive pattern.

FIG. 5 is an equivalent circuit diagram when the nonreciprocal circuit element according to the present invention is applied to an isolator. The earths 5a, 6a, and 7a of the first, second, and third central conductors 5, 6, and 7 are grounded, respectively. The ports 5b and 6b of the first and second central conductors 5 and 6 are connected to the grounded first and second capacitors C1 and C2. The port 7b of the third central conductor 7 is connected to the grounded third capacitor C3 and resistor R.

In the above embodiment, the nonreciprocal circuit element is applied to an isolator. However, the nonreciprocal circuit element may also be applied to a circulator, with the following changes in the structure.

The resistor R is remover from the nonreciprocal circuit element when applied to a circulator. Further, an input and output terminal to which the port 7b of the third central conductor 7 is connected is provided in the circulator. The structure of the circulator excluding the above is similar to the above-mentioned structure.

FIG. 6 is an equivalent circuit diagram when the nonreciprocal circuit element according to the present invention is applied to a circulator. The earths 5a, 6a, and 7a of the first, second, and third central conductors 5, 6, and 7 are grounded, respectively. The ports 5b, 6b, and 7b of the first, second, and third central conductors 5, 6, and 7 are connected to the grounded first, second, and third capacitors C1, C2, and C3, respectively.

The nonreciprocal circuit element according to the present invention includes a flat plate-shaped ferrite member, a first, second, and third central conductors located on the ferrite member on different planes in a vertical direction with dielectric bodies sandwiched therebetween so that parts thereof cross each other in the vertical direction, a magnet arranged on the central conductors, a first yoke arranged so as to cover the magnet, a second yoke arranged on the bottom face of the ferrite member to constitute a magnetic closed circuit together with the first yoke, and an insulating base made of a molded synthetic resin for positioning the ferrite member. A plurality of input and output terminals made of a material having a smaller electric resistance than that of the second yoke is mounted on the insulating base.

As mentioned above, when the input and output terminals are made of a material having a smaller electric resistance than that of the second yoke, it is possible to provide a nonreciprocal circuit element with reduced insertion loss compared to a conventional input and output terminal.

Further, the input and output terminals are made of copper or a copper alloy. Thus, it is possible to provide a nonreciprocal circuit element with reduced electric resistance and further reduced insertion loss.

Further, the input and output terminals are buried in the insulating base. Thus, it is possible to easily manufacture the nonreciprocal circuit element. It is also possible to reduce the number of parts. As a result, it is possible to easily assemble the nonreciprocal circuit element.

Further, the second yoke is buried in the insulating base and is integrated with the insulating base. Thus, it is possible to easily manufacture the nonreciprocal circuit element. It is also possible to reduce the number of parts. As a result, it is possible to easily assemble the nonreciprocal circuit element.

Further, the bottom wall of the insulating base is provided with first and second recesses for exposing the second yoke. The ferrite member is arranged and positioned in the first recess. Further, the earth of the central conductor located on the bottom face of the ferrite member is connected to the second yoke. The capacitor is arranged and positioned in the second recess. Further, a bottom electrode of the capacitor is connected to the second yoke. Therefore, it is possible to easily mount the ferrite member and the capacitor. As a result, it is possible to easily manufacture the nonreciprocal circuit element.

Further, the ports are soldered to the top electrode of the capacitor and the input and output terminals. Thus, it is possible to reduce electric resistance between the central conductors and the input and output terminals. As a result, it is possible to reduce the insertion loss of the nonreciprocal circuit element.

Further, the top electrode of the capacitor and the top faces of the input and output terminals are arranged so that they are flush with each other. Thus, it is possible to firmly solder the ports to the top electrode and the input and output terminals.

Further, the input and output terminals and the second yoke are formed by punching and bending coil stocks and are integrated with the insulating base formed by molding. Thus, it is possible to easily manufacture the nonreciprocal circuit element.

What is claimed is:

1. A nonreciprocal circuit element, comprising:
a flat plate-shaped ferrite member;
first, second, and third central conductors located on the ferrite member on different planes in a vertical direction with dielectric bodies sandwiched therebetween so that parts thereof cross each other in the vertical direction;
a magnet arranged on the central conductors;
a first yoke arranged so as to cover the magnet;
a second yoke arranged on the bottom face of the ferrite member to constitute a magnetic closed circuit together with the first yoke; and
an insulating base made of a molded synthetic resin for positioning the ferrite member,
wherein a plurality of input and output terminals made of a material having a smaller electric resistance than that of the second yoke is mounted on the insulating base.

2. The nonreciprocal circuit element according to claim 1, wherein the input and output terminals are made of copper or a copper alloy.

3. The nonreciprocal circuit element according to claim 1, wherein the input and output terminals are buried in the insulating base.

4. The nonreciprocal circuit element according to claim 3, wherein the second yoke is buried in the insulating base and is integrated with the insulating base.

5. The nonreciprocal circuit element according to claim 4,
wherein the bottom wall of the insulating base is provided with first and second recesses for exposing the second yoke,
wherein the ferrite member is arranged and positioned in the first recess,
wherein earths of the central conductors located on the bottom face of the ferrite member are connected to the second yoke,
wherein a capacitor is arranged and positioned in the second recess, and
wherein a bottom electrode of the capacitor is connected to the second yoke.

6. The nonreciprocal circuit element according to claim 5, wherein the ports are soldered to the top electrode of the capacitor and the input and output terminals.

7. The nonreciprocal circuit element according to claim 6, wherein the top electrode of the capacitor and the top faces of the input and output terminals are arranged so that they are flush with each other.

8. The nonreciprocal circuit element according to claim 4, wherein the input and output terminals and the second yoke are formed by punching and bending coil stocks and are integrated with the insulating base formed by molding.
